(19) United States
(12) Patent Application Publication
(10) Pub. No.: US 2005/0276508 A1
(43) Pub. Date: Dec. 15, 2005

(54) Methods and systems for reducing optical noise

(75) Inventors: Chadwick M. Coleman, Owego, NY (US); Robert S. Lunt IV, Endicott, NY (US)

Correspondence Address: PERKINS, SMITH & COHEN LLP, ONE BEACON STREET, 30TH FLOOR, BOSTON, MA, 02108, US

(73) Assignee: Lockheed Martin Corporation, Bethesda, MD (US)

(21) Appl. No.: 10/868,573

(22) Filed: Jun. 15, 2004

(51) Int. Cl. G06K 9/40

(52) U.S. Cl. 382/275

(57) ABSTRACT

Methods and Systems for reducing or eliminating the optical noise in acquired images. In one embodiment, the method of this invention includes acquiring two images of an object, where, in each of the images, the object subtends a different angle and orientation with respect to a device utilized to acquire the image. Areas of optical noise are identified in each of the two images. The two images are combined in order to obtain areas of reduced optical noise in a composite image. The method can also include aligning the two images with each other and rendering the two images to a common scale. Systems of this invention implement the methods of this invention.

### BACKGROUND OF THE INVENTION

This invention relates generally to imaging, and, more particularly, to image processing.

In various applications, a process of interest includes the acquiring of a digital image. One example of these applications is the acquiring of images of parcels (objects) moving on a conveyor belt with the intent of recognizing information on the parcels (including, but not limited to, barcode recognition, address sorting and indicia matching). When a digital image is acquired, in many instances, the resulting image includes optical noise from sources such glare and specular reflection. In one example, the noise is introduced by glare and specular reflection from a transparent or translucent film on the object being imaged. The optical noise can cause errors in the recognition of information on the objects. In most applications, noise has deleterious effects.

There is a need for methods and Systems for reducing or eliminating the optical noise in acquired images.

There is also in need for methods and Systems for reducing or eliminating the optical noise in acquired images where the method and system can be applied to objects moving on a conveyor belt.

### SUMMARY OF THE INVENTION

Methods and Systems for reducing or eliminating the optical noise in acquired images are disclosed.

In one embodiment, the method of this invention includes acquiring two images of an object, where, in each of the images, the object subtends a different angle and orientation with respect to a device utilized to acquire the image. Areas of optical noise are identified in each of the two images. The two images are combined in order to obtain areas of reduced optical noise in a composite image. The method can also include aligning the two images with each other (where aligning can include, but is not limited to, rotation, stretching, warping and adjusting perspective) and rendering the two images to a common scale (by, for example, resolution equalization).

Systems that implement the methods of this invention are also disclosed.

For a better understanding of the present invention, together with other and further objects thereof, reference is made to the accompanying drawings and detailed description and its scope will be pointed out in the appended claims.

### BRIEF DESCRIPTION OF THE DRAWINGS

FIG. 1 is a flowchart of an embodiment of the method of this invention;

FIG. 2 is a flowchart of an embodiment of a step in the method of this invention;

FIG. 3 depicts a graphical schematic representation of a configuration in an embodiment of a system of this invention;

FIG. 4 depicts a graphical schematic representation of another configuration in an embodiment of the system of this invention;

FIG. 5a is a pictorial schematic representation of a grayscale image acquired by an embodiment of the system of this invention;

FIG. 5b is a pictorial schematic representation of another grayscale image acquired by an embodiment of the system of this invention;

FIG. 6a is a pictorial schematic representation of a binary image acquired by an embodiment of the system of this invention;

FIG. 6b is a pictorial schematic representation of another binary image acquired by an embodiment of the system of this invention; and

FIG. 7 is a block diagram representation of an embodiment of the system of this invention.

### DETAILED DESCRIPTION OF THE PREFERRED EMBODIMENTS

Methods and Systems for reducing or eliminating the optical noise in acquired images are described herein below.

While the embodiments described herein below are described in relation to acquired digital images, it should be noted that the methods and systems of this invention also apply to acquired images that are subsequently digitized. In embodiments in which the image is subsequently digitized, the image is acquired and then a digital version of the image is obtained. In digital image embodiments, the digital version of the image is obtained during acquisition.

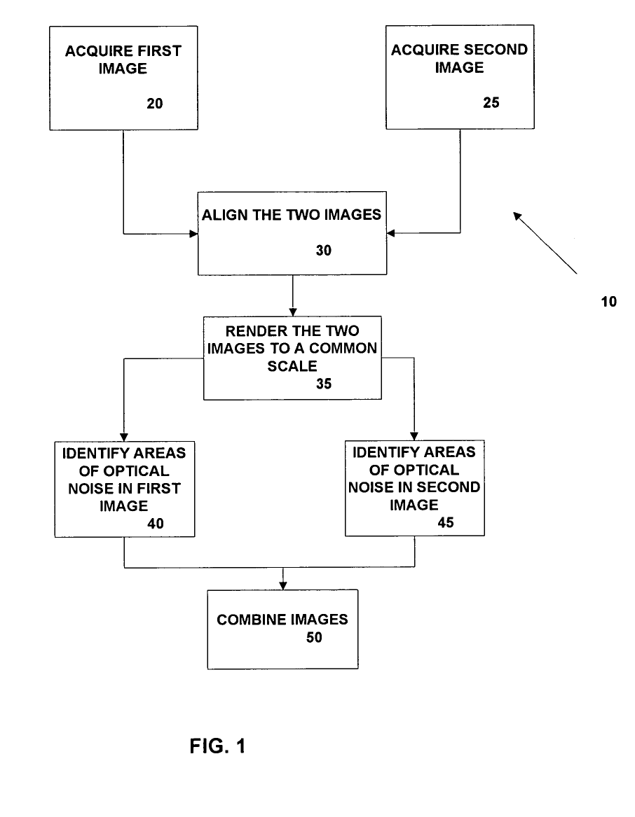

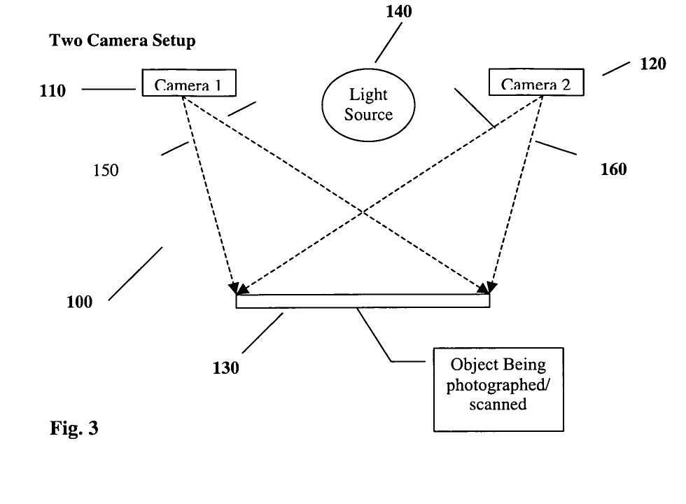

A flowchart of an embodiment of a method of this invention is shown in FIG. 1. Referring to FIG. 1, the method of this invention 10 includes acquiring a first digital image of an object (step 20, FIG. 1) and acquiring a second digital image of an object (step 25, FIG. 1). In the first digital image, the object subtends a first angle/orientation with respect to a device utilized to acquire the first digital image. (Referring to FIG. 3, in the embodiment shown in FIG. 3, the object 130 constitutes a side of a triangle in which an acquisition device 110, 120 is at the vertex opposite the object 130. The object 130 subtends an opposite angle 150, 160, hereinafter referred to as angle with respect to the image acquisition device 110, 120.) In the second digital image, the object subtends a second angle/orientation with respect to a device utilized to acquire the second digital image. Since one of the sources of the optical noise is specular reflection from reflecting surfaces on the object, the first and second angle/orientation are selected such that one set of rays of light emanating from a light source and reflected from some of the reflecting surfaces on the object arrives at the corresponding image acquisition device for the first angle/orientation while another set of rays of light emanating from a light source and reflected from others of the reflecting surfaces arrives at the corresponding image acquisition device for the second angle/orientation. Herinafter, the angle/orientation combination is also referred to as orientation with respect to an acquisition device. Areas of optical noise in the first digital image and in the second digital image are identified (steps 40, 45, FIG. 1). The first digital image and the second digital image are combined in order to obtain areas of reduced optical noise in a composite image (step 50, FIG. 1). In one embodiment, the combining of the two digital images includes replacing a value of the first digital image at each of the identified areas of optical noise in the first digital image with a value of the second digital image at a corresponding area.

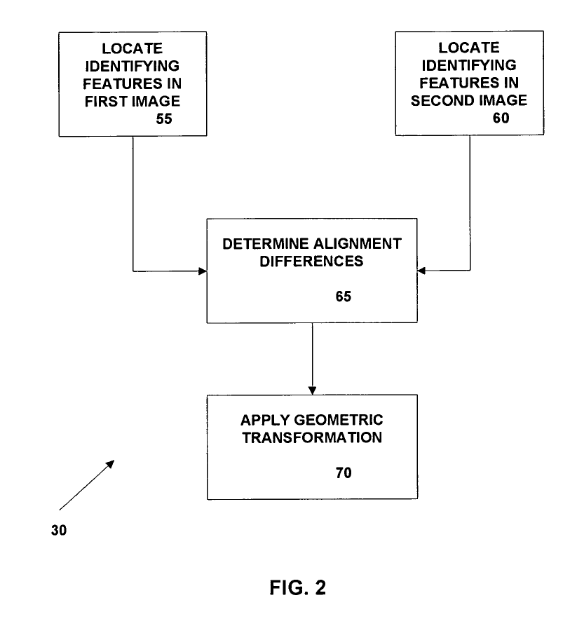

In some embodiments, since the first digital image and the second digital image are acquired at different angles/orientations, the first digital image and the second digital image are at different perspectives (the same feature in the object appears at a different size or angle in each image). In order to combine the first digital image and the second digital image, the size and alignment of the images must be substantially equal. The process of rendering the size and alignment of the images substantially equal will be referred to hereinafter as aligning the first digital image with the second digital image (step 30, FIG. 1). One embodiment of the method 30 for aligning the first digital image with the second digital image is shown in FIG. 2. Referring to FIG. 2, the method includes locating identifying features in each image (steps 55, 60, FIG. 2), determining alignment differences between corresponding identifying features (step 65, FIG. 2), and, applying geometric transformations to substantially eliminate the alignment differences (step 70, FIG. 2). The identifying features can be, but are not limited to, identifying marks on the image—such as, for example, barcodes, address blocks or postageon parcels, in on embodiment, or, edges—such as the borders of a grayscale image, in another embodiment. The geometric transformation can be expressed as a mapping function that relates the points in one digital image to corresponding points in the other digital image. The mapping may be represented

$$x = {\sum }_{i = 0}^{N} {\sum }_{j = 0}^{N} {a}_{i , j} {u}^{i} {v}^{j}$$

$$y = {\sum }_{i = 0}^{N} {\sum }_{j = 0}^{N} {b}_{i , j} {u}^{i} {v}^{j}$$

where the mapping translates one image, having coordinates u,v to another image having coordinates x,y. The coefficients a_{i,j} and b_{i,j} can be constants or can be functions of u,v. The above expressions include translations, rotations and stretching as limiting cases.

In the limiting case of rotations, a variety of implementations of the method for rotating an image have been developed, such as those described in U.S. Pat. No. 5,475,803 and references described therein. Or, in order to make the rotation procedure less computationally and memory intensive, other or additional means can be utilized, such as described in U.S. Pat. No. 6,275,622, U.S. Pat. No. 6,310,986, in U.S. Pat. No. 5,889,893 and in col. 14, lines 1-25 and FIG. 35 of U.S. Pat. 5,111,514 (for the embodiment in which the electronic signal comprises a two dimensional array of discrete image values). As in the limiting case of rotations, the above expressions for geometric transformations could be implemented in a variety of algorithms. A related group of algorithms, referred to as “warping,” for implementing geometric transformations are conventionally used and could be applied in the present invention.

For every individual point (pixel) in an acquired image, there is a corresponding pixel value. In order to combine two digital images, each image must have substantially the same number of pixels in a given distance along each coordinate. Since the first digital image and the second digital image are acquired at different angles/orientations, and also possibly as the result of geometric transformations, the number of pixels in a given distance along each coordinate could be different for the first digital image and the second digital image. In order to combine the first digital image and the second digital image, the two digital images should be rendered to a common number of pixels in a given distance along each coordinate (herinafter referred to as rendering the first digital image and the second digital image to a common scale) (step 35, FIG. 1). Rendering the first digital image and the second digital image to a common scale can be accomplished by “up sampling” or “down sampling” or interpolation. Interpolation algorithms include, but are not limited to, linear, nearest-neighbor, Lagrange- and Gaussian-based interpolators, Blackman-Harris windowed-sinc kernels, quadratic and cubic convolution, and cubic B-spline. Descriptions of these techniques are given in A Chronology of Interpolation: From Ancient Astronomy to Modern Signal and Image Processing, Meijering, E., Proceedings of the IEEE, Vol. 90, No. 3, March 2002, incorporated in its entirety herein by reference. “Up sampling” or “down sampling” methods, such as those described in Gilbert Strang, Truong Nguyen, Wavelets and Filter Banks, ISBN 0-9614088-7-1, pp. 87-94, but not limited to, could also be used.

It should be noted that, in embodiments in which by design or otherwise, the size (scale) and alignment of the two or more acquired images are substantially equal, it is not necessary to render the two or more acquired images to the same scale or to align the two or more acquired images.

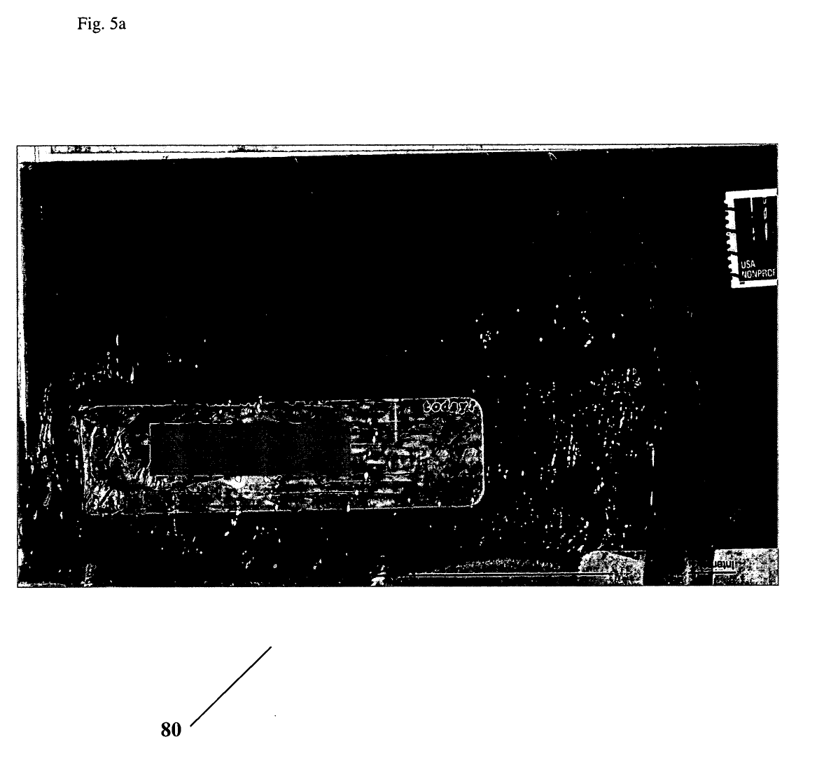

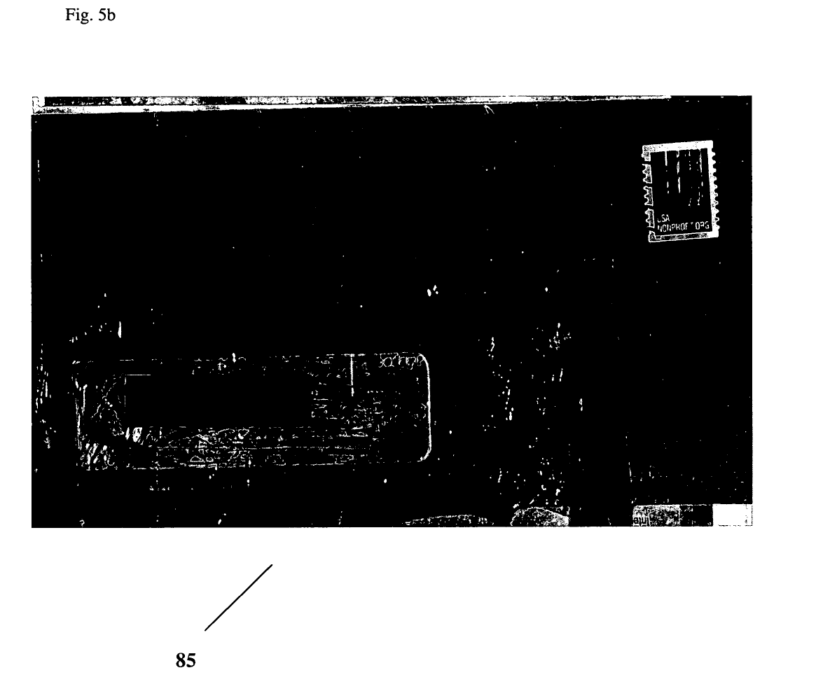

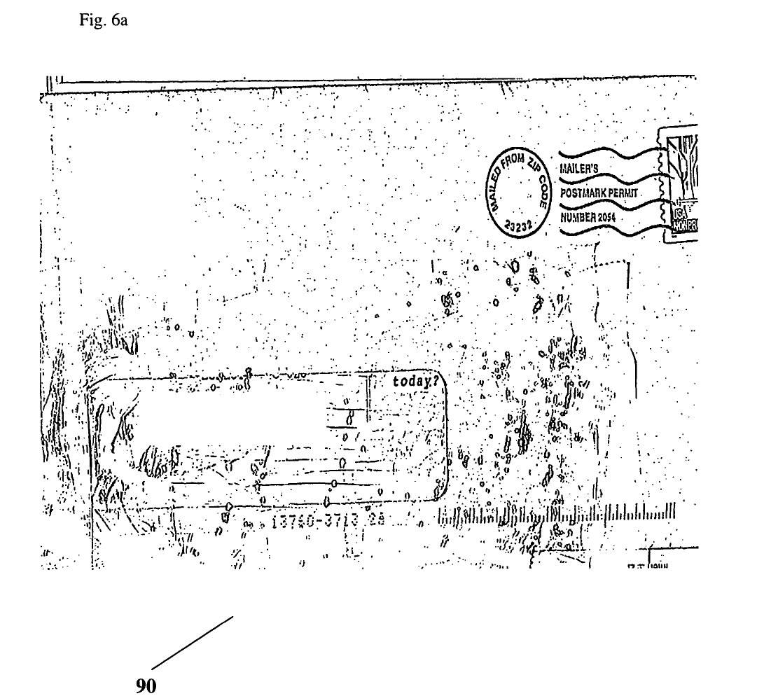

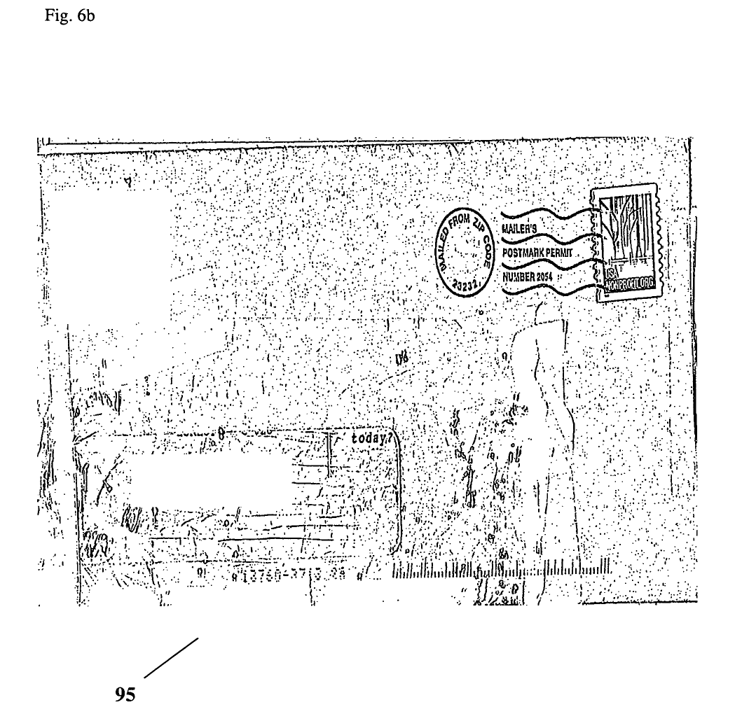

Embodiments of the step of identifying areas of optical noise in the method of this invention may, but are not limited to, differ for different image types. Shown in FIGS. 5a and 5b are pictorial schematic representations of grayscale images 80, 85 acquired by an embodiment of the system of this invention. FIGS. 6a and 6b show pictorial schematic representations of binary images 90, 95 acquired by an embodiment of the system of this invention. Since the first digital image and the second digital image are captured at different angles/orientations, the areas of specular reflection in the first digital image and the second digital image will, in most embodiments, correspond to different locations in the object. In grayscale images, specular reflection typically generates a substantially (bright) white value, which is characteristic of areas of specular reflection. In identifying areas of optical noise (specular reflection) in one digital image, each pixel value in the image is compared a predetermined value in order to determine if the pixel value is included in an area of specular reflection (optical noise). The comparison can be, but is not limited to, performed in a pixel by pixel manner or, in and other embodiment, may be performed over a group of pixels. In one embodiment, one or more pixel values in one image are compared to one or more corresponding pixel values in another image. In another embodiment, the one or more pixel values in the image are compared to a predetermined value, such as but not limited to, the median or mean value of the pixels in the image.

Binary images can be obtained by thresholding a grayscale image or can be obtained directly by thresholding the acquired pixel values to arrive at images with two possible pixel values, labeled one and zero or black and white. In some embodiments, areas of specular reflection generate black outlines with white centers. In embodiments that generate black outlines with white centers for areas of specular reflection, the search for areas of specular reflection could, but is not limited to, be performed over group of pixels.

In an embodiment of the method 10 of this invention, the step (step 50, FIG. 1) of combining the first digital image and the second digital image includes, in one embodiment, replacing a value of the first digital image at each of the identified areas of optical noise in the first digital image with a value of the second digital image at a corresponding area.

An embodiment of the system of this invention includes one or more image acquisition devices and means for providing an acquisition configuration enabling acquiring at least two images of an object. In one embodiment, the images are digital images. In the first digital image, the object subtends a first angle/orientation with respect to a device utilized to acquire the first digital image. In the second digital image, the object subtends a second angle/orientation with respect to a device utilized to acquire the second digital image. FIG. 3 depicts a configuration 100 enabling acquiring two images of an object 130 in an embodiment of a system of this invention. Referring to FIG. 3, the object 130 constitutes a side of a triangle in which an acquisition device 110, 120 is at the vertex opposite the object 130. The object 130 subtends an opposite angle 150, 160, referred to as angle with respect to the image acquisition device 110, 120. Since one of the sources of the optical noise is specular reflection from reflecting surfaces on the object, the first and second angle/orientation are selected such that one set of rays of light emanating from a light source and reflected from some of the reflecting surfaces on the object arrives at the corresponding image acquisition device for the first angle/orientation while another set of rays of light emanating from a light source and reflected from others of the reflecting surfaces arrives at the corresponding image acquisition device for the second angle/orientation. In the configuration shown in FIG. 3, two image acquisition device 110, 120 are utilized. Image acquisition devices include, but are not limited to, video cameras, digital cameras, and area and line acquisition devices such as CCDs and CMOS imaging devices. In the embodiment of FIG. 3, the distance between the object 130 and the image acquisition device 110 and the distance between the object 130 and the image acquisition device 120 should be approximately equal and the two image acquisition devices have substantially the same number of pixels and substantially the same pixel geometry (resulting in substantially the same resolution—pixels/inch).

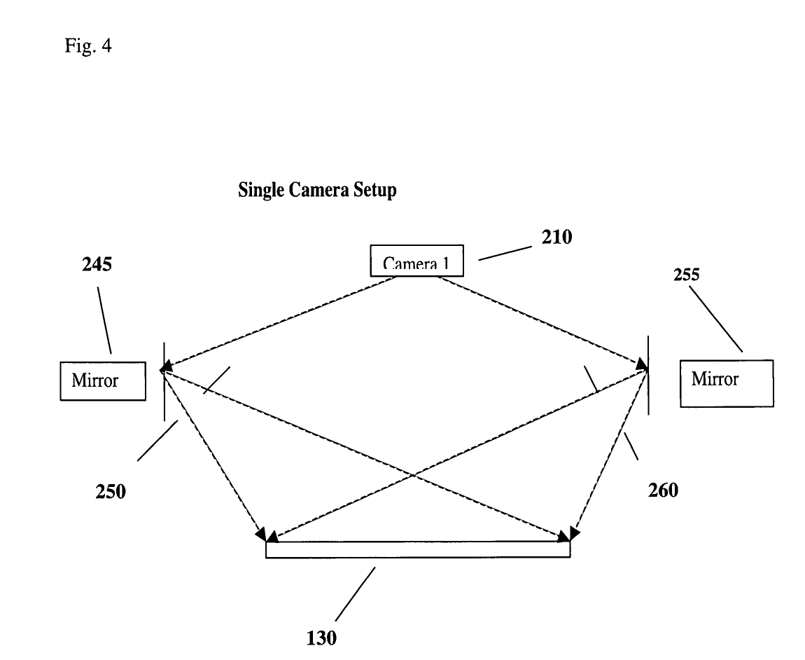

FIG. 4 depicts another configuration 200 enabling acquiring two images of the object 130 in an embodiment of a system of this invention. Referring to FIG. 4, the object 130 constitutes a side of each of two folded triangles in which an acquisition device 210 is at the vertex opposite the object 130. The object 130 subtends an opposite angle 250, 260, hereinafter referred to as angle with respect to the image acquisition device 210. Mirrors 245, 255 serve to fold the triangles, enabling the acquiring of two images with one acquisition device 210. The acquisition of the second image is slightly delayed from the acquisition of the first image. Other configurations are possible. For example, the image acquisition device 210 could be moved (faster than the object if the object is moving) from one position to another position, simulating the configuration of FIG. 3. In that embodiment, the distance between the object 130 and the image acquisition device 210 should be maintained approximately constant.

The acquisition configuration is provided by conventional structures described below. A planar structure supports the object 130 in one embodiment, the planar structure may be, but is not limited to, a conveyor belt. At a given distance perpendicular to the planar structure, conventional support structures, such as, but is not limited to, brackets or attaching structures or posts and attaching structures or support planar structures onto which the image acquisition device can be secured, provide the acquisition configuration. Similarly, at another distance perpendicular to the planar structure, in one embodiment, mirrors 245, 255 are optically disposed in order to fold the to fold the triangles. The mirrors 245, 255 and conventional support structures, such as, but is not limited to, brackets or attaching structures or posts and attaching structures or support planar structures onto which the mirrors can be secured, also provide the acquisition configuration. If a single image acquisition device is used and the image acquisition device is translated from one position to another position, a motion inducing component, such as, but is not limited to, a conveyor belt or a motor and actuator or a motor and linkages, an a structure that supports the acquisition device as it is displaced, also are used to provide the acquisition configuration.

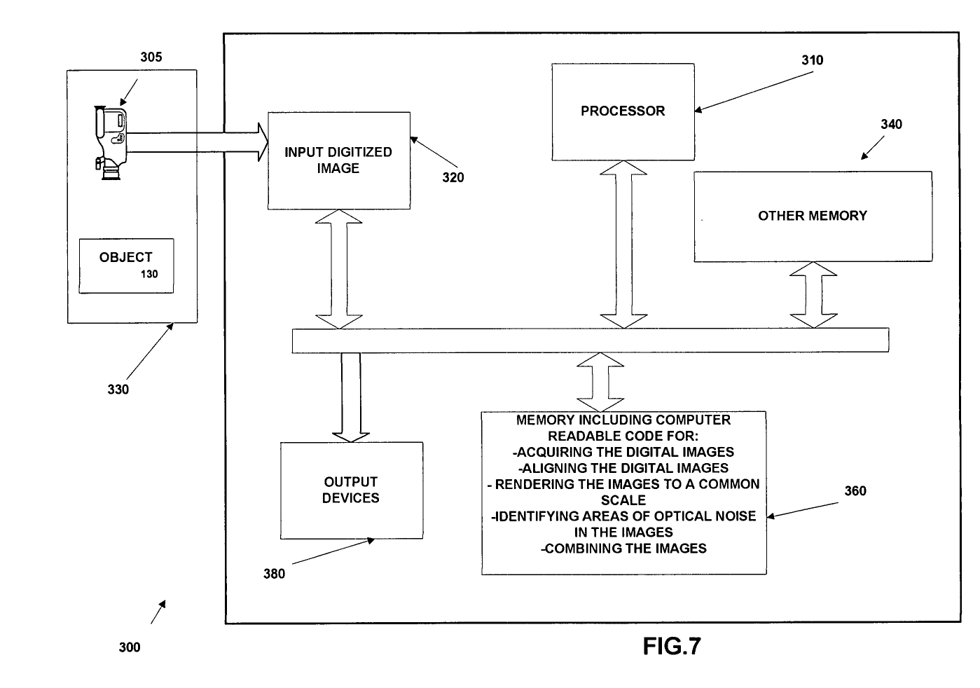

The system of this invention also implements the methods of this invention for identifying areas of optical noise in each of the two or more digital images, for aligning one of the two or more digital images with another one of the two or more digital images, for rendering one of the two or more digital images and another one of the two or more digital images to a common scale, and for combining the two or more digital images in order to obtain areas of reduced optical noise in a composite image. A block diagram of an embodiment 300 of the system of this invention is shown in FIG. 7.

Referring to FIG. 7, configuration 330 enables the acquiring of two or more digital images of the object 130. In one embodiment of configuration 330, the embodiment 100 shown in FIG. 3 is utilized. In another embodiment of configuration 330, the embodiment 200 shown in FIG. 4 is utilized. The acquisition system 305 can, in the embodiment shown in FIG. 7, consist of one or more digital acquisition devices. The one or more digital acquisition devices acquire at least two digital images. In each image of the at least two digital images, the object 130 subtends a different angle/orientation with respect to one of the image acquisition devices in the acquisition system 305. The acquisition system 305 is operably connected to an input system 320. The input system 320 is operably connected to a interconnection means 315 (such as, but not limited to, a common “bus”) One or more processors 310, a memory 360, another memory 340, and output devices 380 are also operably connected to the interconnection means 315. The memory 360 has computer readable code embodied therein, the computer readable code capable of causing the one or more processors 310 to align one of the at least two digital images with another one of the at least two digital images, render one of the at least two digital images and another one of the at least two digital images to a common scale, identify areas of optical noise in each one of at least two digital images, and combine the at least two digital images in order to obtain areas of reduced optical noise in a composite image. In one embodiment, the code that causes the one or more processors 310 to align one of the at least two digital images with another one of the at least two digital images is capable of causing the one or more processors 310 to locate identifying features in each of the at least two digital images, determine alignment differences between corresponding identifying features, and, apply geometric transformations to substantially eliminate the alignment differences. In one embodiment of the code that causes the one or more processors 310 to combine the at least two digital images, the code causes the one or more processors 310 to replace a value of one of the at least two digital images at each of the identified areas of optical noise in the one of the at least two digital images with a value of another one of the at least two digital images at a corresponding area.

The other memory 340 in the embodiment 300 of the system of this invention shown in FIG. 7 is typically used for various housekeeping and operational purposes but can also be used to provide a buffer memory for the combining of the at least two digital images. (In many algorithms for combining or updating an image, the image to be updated or one of the images to be combined is copied to a buffer memory and the operations performed on the copy of the image.)

While the embodiments described above were described in relation to acquired digital images, it should be noted that the methods and systems of this invention also apply to acquired images that are subsequently digitized. In those embodiments, the image is acquired and then a digital version of the image is obtained. In digital image embodiments, the digital version of the image is obtained during acquisition. The possible embodiments range from acquiring an analog image and then digitizing the image to obtain a digital version (including acquiring a pixellated analog image and subsequently digitizing the pixellated image) to acquiring a digital image. The terms digital version of the image and digital image are used interchangeable herein.

It should be noted that, although in the embodiments shown in FIGS. 3 and 4 the measure of the angles in both orientations is substantially the same, that condition is not a required limitation of this invention and embodiments of this invention in which the measure of the angles in both orientations is not substantially the same are within the scope of this invention.

In general, the techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to data entered using the input device to perform the functions described and to generate output information. The output information may be applied to one or more output devices.

Elements and components described herein may be further divided into additional components or joined together to form fewer components for performing the same functions.

Each computer program (code) within the scope of the claims below may be implemented in any programming language, such as assembly language, machine language, a high-level procedural programming language, or an object-oriented programming language. The programming language may be a compiled or interpreted programming language.

Each computer program may be implemented in a computer program product tangibly embodied in a computer-readable storage device for execution by a computer processor. Method steps of the invention may be performed by a computer processor executing a program tangibly embodied on a computer-readable medium to perform functions of the invention by operating on input and generating output.

Common forms of computer-readable or usable media include, for example, a floppy disk, a flexible disk, hard disk, magnetic tape, or any other magnetic medium, a CDROM, any other optical medium, punched cards, paper tape, any other physical medium with patterns of holes, a RAM, a PROM, and EPROM, a FLASH-EPROM, any other memory chip or cartridge, a carrier wave, or any other medium from which a computer can read.

Although the invention has been described with respect to various embodiments, it should be realized this invention is also capable of a wide variety of further and other embodiments within the spirit and scope of the appended claims.

1. A method for reducing optical noise in images, the method comprising the steps of:
acquiring a first image of an object, the object subtending a predetermined orientation with respect to a device utilized to acquire the first image;
acquiring a second image of the object, the object subtending another predetermined orientation with respect to a device utilized to acquire the second image;
identifying areas of optical noise in the first image;
identifying areas of optical noise in the second image; and,
combining a digital version of the first image and a digital version of the second image in order to obtain areas of reduced optical noise in a composite image.

2. The method of claim 1 further comprising the step of:
aligning the first image with the second image.

3. The method of claim 2 wherein the step of aligning the first image with the second image comprises the steps of:
locating identifying features in each of the first image and the second image;
determining alignment differences between corresponding identifying features; and,
applying geometric transformations to substantially eliminate the alignment differences.

4. The method of claim 1 wherein the step of combining the digital version of the first image and the digital version of the second image comprises the step of:
replacing a value of the digital version of the first image at each of the identified areas of optical noise in the first image with a value of the digital version of the second image at a corresponding area.

5. The method of claim 1 further comprising the step of:
rendering the first image and the second image to a common scale.

6. A system for reducing optical noise in images, the system comprising:
an image acquisition device;
means for providing at least two acquisition configurations enabling acquiring at least two images of an object; in each image of the at least two images, the object subtends a different predetermined orientation with respect to the image acquisition device;
means for identifying areas of optical noise in each of at least two acquired images;
means for combining the at least two images in order to obtain areas of reduced optical noise in a composite image.

7. The system of claim 6 further comprising:
means for aligning one of the at least two images with another one of the at least two images.

8. The system of claim 7 wherein the means for aligning one of the at least two images with another one of the at least two images comprise:
means for locating identifying features in each of the at least two images;
means for determining alignment differences between corresponding identifying features;
means for applying geometric transformations to substantially eliminate the alignment differences.

9. The system of claim 6 wherein the means for combining the at least two images comprise:
means for replacing a value of a digital version of one of the at least two images at each of the identified areas of optical noise in said one of the at least two images with a value of a digital version of another one of the at least two images at a corresponding area.

10. The system of claim 6 further comprising:
means for rendering one of the at least two images and another one of the at least two images to a common scale.

11. A system for reducing optical noise in images, the system comprising:
two image acquisition devices;
the two image acquisition devices being capable of acquiring at least two images of an object; in each image of the at least two images, the object subtends a different predetermined orientation with respect to one of the two image acquisition device;
means for identifying areas of optical noise in each of the at least two images;
means for combining the at least two images in order to obtain areas of reduced optical noise in a composite image.

12. The system of claim 11 further comprising:
means for aligning one of the at least two images with another one of the at least two images.

13. The system of claim 12 wherein the means for aligning one of the at least two images with another one of the at least two images comprise:
means for locating identifying features in each of the at least two images;
means for determining alignment differences between corresponding identifying features;
means for applying geometric transformations to substantially eliminate the alignment differences.

14. The system of claim 11 wherein the means for combining the at least two images comprise:
means for replacing a value of a digital version of one of the at least two images at each of the identified areas of optical noise in the one of the at least two images with a value of a digital version of another one of the at least two images at a corresponding area.

15. The system of claim 11 further comprising:
means for rendering one of the at least two images and another one of the at least two images to a common scale.

16. A computer program product comprising:
a computer usable medium having computer readable code embodied therein, the computer readable code capable of causing at least one processor to:
identify areas of optical noise in each one of at least two digital images, and
combine the at least two digital images in order to obtain areas of reduced optical noise in a composite image;
where in each image of the at least two digital images, an object subtends a different orientation with respect to an image acquisition device.

17. The computer program product of claim 16 wherein the computer readable code is also capable of causing the at least one processor to:
align one of the at least two digital images with another one of the at least two digital images.

18. The computer program product of claim 16 wherein the computer readable code is also capable of causing the at least one processor to:
render one of the at least two digital images and another one of the at least two digital images to a common scale.

19. The computer program product of claim 17 wherein the computer readable code that is capable of causing the at least one processor to align one of the at least two digital images with another one of the at least two digital images is capable of causing the at least one processor to:
locate identifying features in each of the at least two digital images,
determine alignment differences between corresponding identifying features; and,
apply geometric transformations to substantially eliminate the alignment differences.

20. The computer program product of claim 17 wherein the computer readable code that is capable of causing the at least one processor to combine the at least two digital images is capable of causing the at least one processor to:
replace a value of one of the at least two digital images at each of the identified areas of optical noise in the one of the at least two digital images with a value of another one of the at least two digital images at a corresponding area.
